(19) United States
(12) Patent Application Publication
(10) Pub. No.: US 2014/0305955 A1
(43) Pub. Date: Oct. 16, 2014

(54) Chafer Protective Wrap

(71) Applicant: Judy C. LEE, Garland, TX (US)

(72) Inventor: Judy C. LEE, Garland, TX (US)

(21) Appl. No.: 14/101,850

(22) Filed: Dec. 10, 2013

Related U.S. Application Data
(60) Provisional application No. 61/812,622, filed on Apr. 16, 2013.

(51) Int. Cl. A47J 36/36

(52) U.S. Cl. CPC A47J 36/36
USPC 220/739

(57) ABSTRACT

A chafer protective wrap includes an insulating member, where the insulating member is wrapped around a metal chafer in order to protect the igniting chafing fuel. The insulating member also improves the heat transfer to the food as it minimizes the heat escape. Elongated extremities of the insulating member are removably attached to each other by at least one wall fastener creating loop around the metal chafer, and the insulating member is removably attached to the metal chafer by a plurality of tabs and a plurality of tab fasteners. The insulating member also includes a pair of slit openings, where the pair of slit openings is used to access the interior of the metal chafer when the insulating member is positioned around the metal chafer.

The current application claims a priority to the U.S. Provisional Patent application Ser. No. 61/812,622 filed on Apr. 16, 2013.

### FIELD OF THE INVENTION

The present invention relates generally to chafers which are commonly utilized at buffets and in the catering industry. More specifically, the present invention is a chafer protective wrap which is designed to wrap the chafer, blocking out wind and containing heat from the burning chafing fuel.

### BACKGROUND OF THE INVENTION

Good food is a key element of nearly all human cultures. Most human cultures on the planet have developed a unique style of cooking and eating food utilizing nearby resources including but not limited to meats, vegetables, fruits, grains, and spices. These resources are crafted into various different dishes which can possess a multitude of different flavors and textures. The process of creating these different dishes is known as the art of cooking.

In most cultures, food serves not only as a source of vital nutrients, but as a way to facilitate socialization between individuals. Additionally, a family having regular meal together serves as a way for the family to catch up and discuss the activities and events which each member of the family has recently been involved in. This also applies to friends and coworkers who may use a meal to not only take in sustenance, but also to socialize, get to know each other better, and catch up with one another on past events. Indeed many important issues are often discussed over a meal, where participants are most likely to be happy and agreeable as a result of the delicious food being served.

As a result of the potency of food as a social facilitator, food is often served at parties and other events which involve the gathering of a plurality of people. The logistics of providing a sufficient amount of food to a party or other social event are quite complicated. It is important to ensure that there is enough food for everyone at the party, lest the party guests become upset and irritable. Furthermore there is the issue of serving the food and keeping the food at an appropriate temperature for consumption by the party guests. The appropriate temperature may be above, below, or equal to the ambient temperature in the environment where the party is taking place. In the ambient case, the food is very easy to serve as all that is necessary is some sort of vessel to contain the food and keep out insects, and some sort of serving utensil. Keeping a food below the ambient temperate is typically accomplished through the use of insulated containment vessels and sometimes the application of ice or freeze packs. Maintaining a food at higher than ambient temperature also involves the use of an insulated containment vessel, however a heat source of some kind must also be present in order to keep the food at a safe temperature.

There are many different ways in which a food containment vessel can be heated, however perhaps the most common method is the use of a chafer. A chafer is a metal frame which suspends a tray of water some distance off of a surface. Additional trays of food are placed into the tray of water. The chafer also possesses chafing fuel slots below where the water and food trays are suspended. The chafing fuel is typically ignited, and then burns for a period of several hours, during which the chafing fuel gives off heat which is absorbed into the water and food trays and the food within; thus maintaining the food at a temperature higher than ambient. Chafing fuel is very useful in that it is self-contained, and can be used to keep foods warm even in locations where no electrical power sources are available such as outside. As a result of this, chafers and chafing fuel are quite popular in the catering industry and are regularly utilized in the industry to keep large volumes of food warm before consumption by event guests.

Unfortunately, there are some disadvantages to chafing fuel despite the obvious advantages as highlighted above. For starters, the fuel must be burned in order for the heat to be produced. This makes it easy for accidents to happen; a worker may accidentally burn his or her hand, or a flammable material such as a paper napkin may easily be ignited in a moment of carelessness by an event patron or worker. The other glaring disadvantage of chafing fuel is the fact that it can be extinguished by significant gusts of wind, thus causing additional consternation for event workers who must reignite the chafing fuel. Attempts to correct this problem have typically ended in conflict with the first disadvantage of chafing fuel. Other covers make use of material which is too flexible and can be blown into the chafing fuel, thus failing to protect the chafing fuel from the wind as well as posing a potential fire hazard.

It is an object of the present invention to correct these flaws by introducing a chafer protective cover which is flexible enough to be wrapped around a chafer, but rigid enough such that it is not possible for the cover to be dislodged by gusts of wind. The present invention additionally makes use of heat and flame resistant material to further increase the safety of the device. Furthermore the heat resistance of the material used also serves to increase the efficiency of the chafing fuel by helping to prevent heat from bleeding to the surrounding environment, thus causing more heat to be absorbed by the food.

### BRIEF DESCRIPTION OF THE DRAWINGS

FIG. 1 is a perspective view of the present invention.

FIG. 2 is an exterior side view of the present invention.

FIG. 3 is an interior side view of the present invention.

FIG. 4 is a perspective view of the present invention, showing the present invention is wrapped around a metal chafer.

FIG. 5 is a top view of the present invention, showing the present invention is wrapped around the metal chafer where the detailed view of section A is shown in FIG. 6.

FIG. 6 is a detailed view of section A of the FIG. 5.

FIG. 7 is a side view of the present invention, showing the second lateral wall.

FIG. 8 is another side view of the present invention, showing the fourth lateral wall.

FIG. 9 is another side view of the present invention, showing the first lateral wall.

FIG. 10 is another side view of the present invention, showing the fourth lateral wall.

### DETAIL DESCRIPTIONS OF THE INVENTION

All illustrations of the drawings are for the purpose of describing selected versions of the present invention and are not intended to limit the scope of the present invention.

The present invention is a chafer protective cover that comprises an insulating member 1, a plurality of tabs 2, a plurality of tab fasteners 3, and at least one wall fastener 4. The present invention is intended to block wind from reaching the interior of a metal chafer where the chafing fuel is suspended; therefore, it is critical that the insulating member 1 is made into proper dimensions in order to achieve this. Obviously, there may be many different sized chafers, and the present invention may be easily modified to better suit the different sized chafers as deemed necessary by the manufacturers of the present invention.

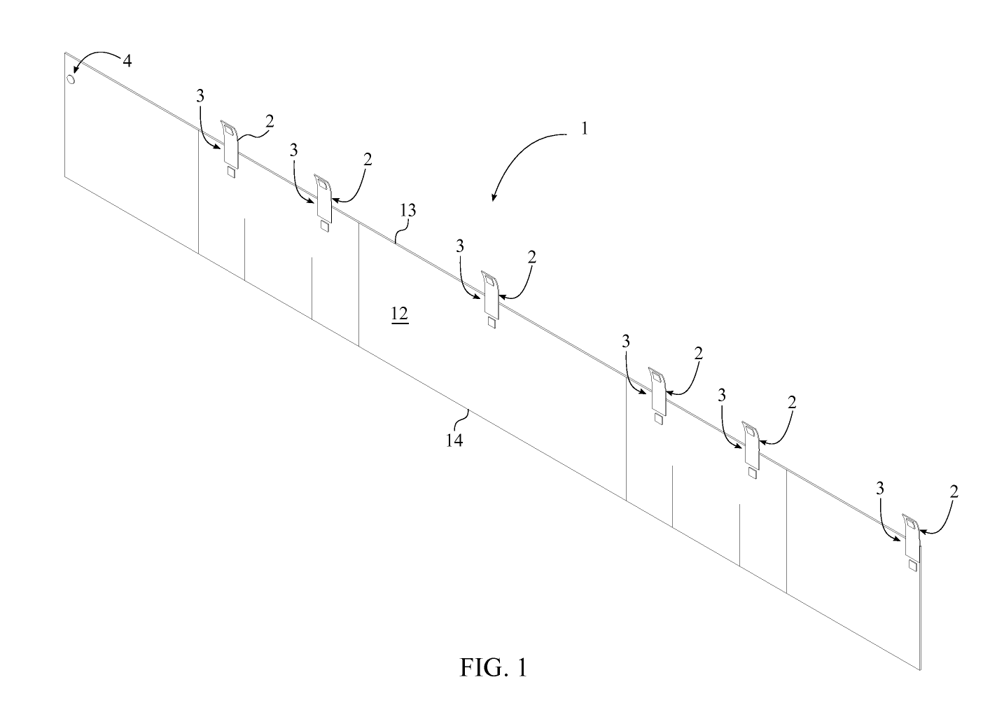

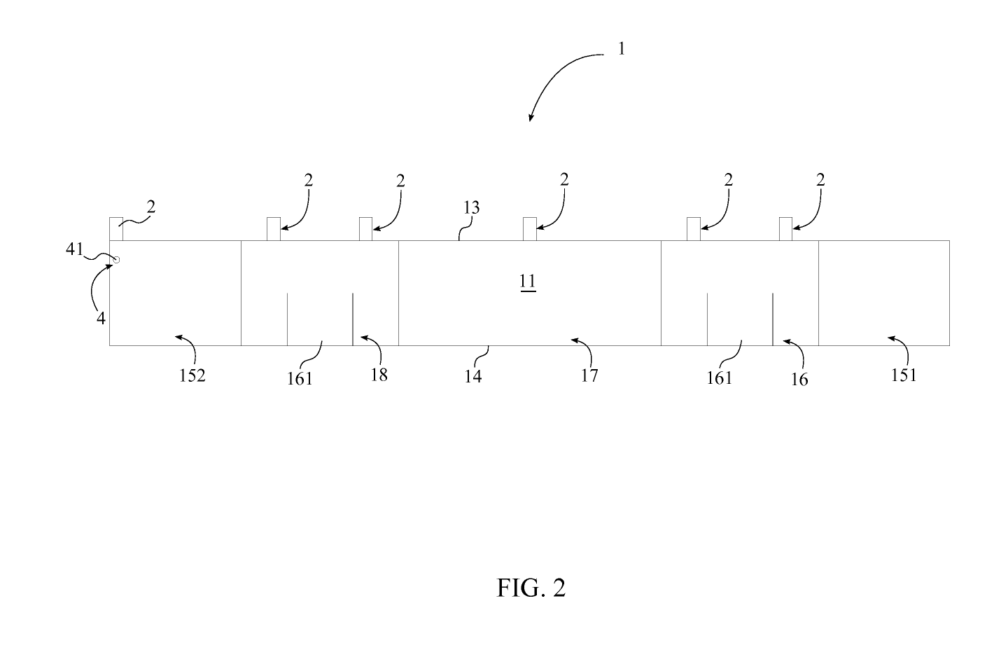

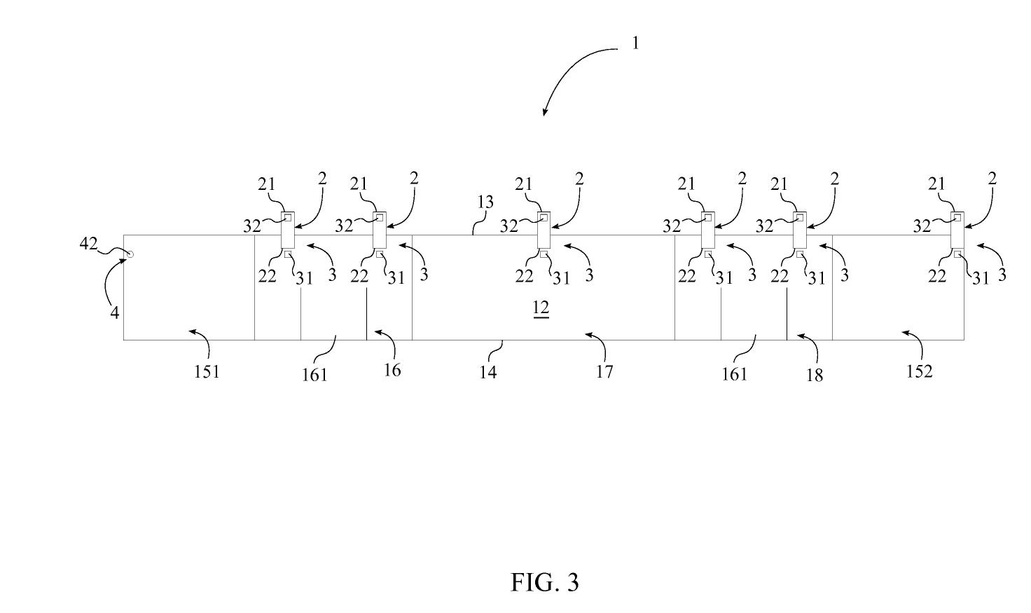

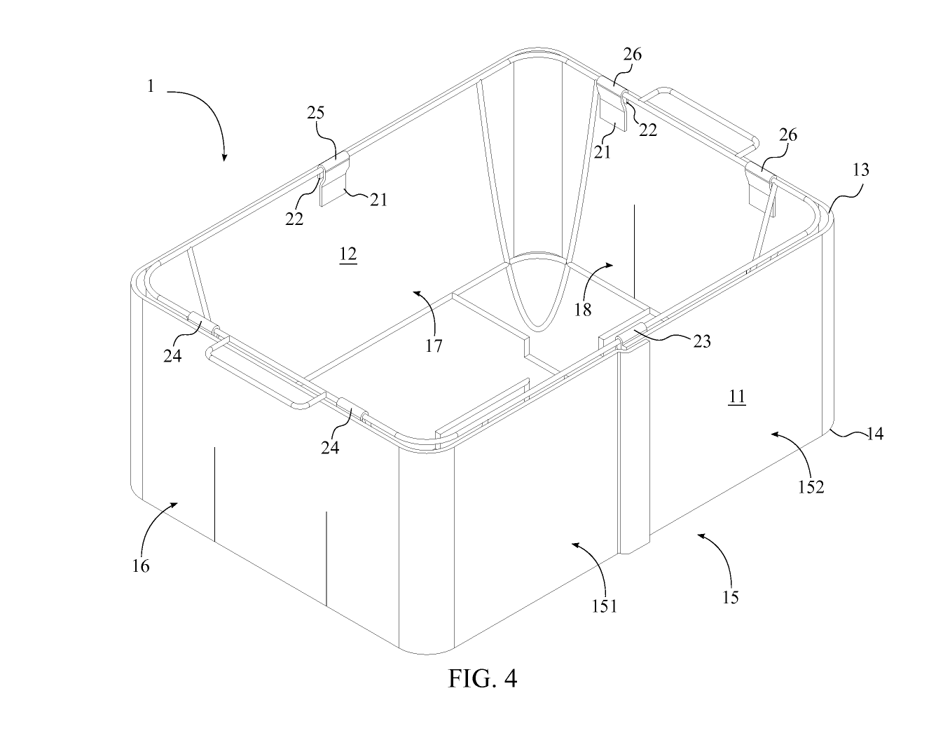

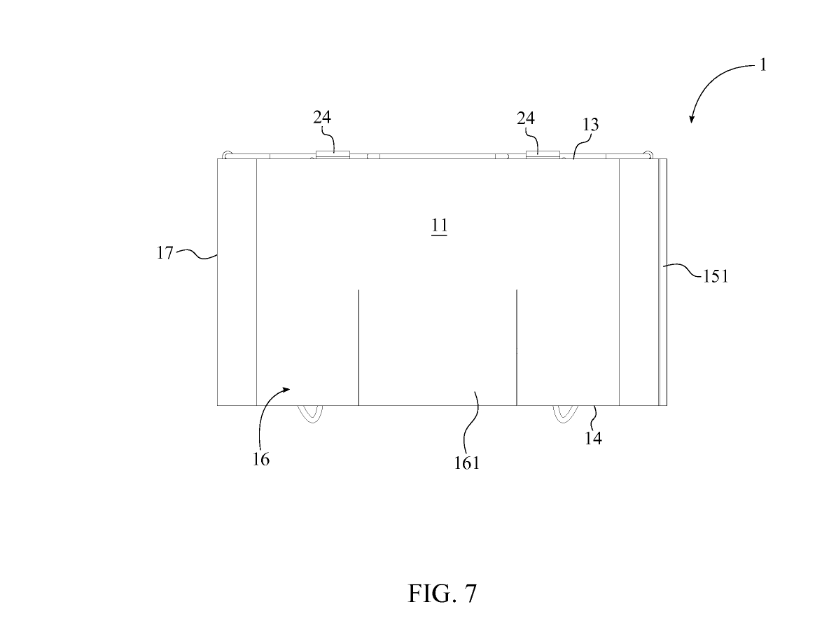

The insulating member 1 of the present invention is the main component of the present invention, with all other components attached to the insulating member 1 in some way. The insulating member 1 is generally rectangular in shape with a length that is sufficient for the insulating member 1 to wrap around the metal chafer as seen in FIG. 4. Additionally, the height of the insulating member 1 must be sufficient such that the all four sides of the metal chafer are covered from top to bottom as can be seen in FIG. 7-FIG. 10. A small gap is provided in between the bottom of the insulated member and the bottom of the metal chafer so that airflow continues to flow into the flame of the chafer fuel in order for the flame to remain ignited. In reference to FIG. 1, FIG. 2, and FIG. 3, the insulating member 1 comprises an exterior panel 11, an interior panel 12, a top edge 13, a bottom edge 14, a first lateral wall 15, a second lateral wall 16, a third lateral wall 17, and a fourth lateral wall 18. The exterior panel 11 and the interior panel 12 are oppositely positioned from each other along the insulating member 1, where the exterior panel 11 generally faces outward from the metal chafer and the interior panel 12 generally faces inward towards the metal chafer. The top edge 13 is positioned atop the exterior panel 11 and the interior panel 12 in such way that the top edge 13 is adjacently positioned with the upper end of the metal chafer when the insulating member 1 is positioned around the metal chafer. The bottom edge 14 is positioned along the exterior panel 11 and the interior panel 12 opposite from the top edge 13, where the bottom edge 14 is adjacently positioned with the lower end of the metal chafer when the insulating member 1 is positioned around the metal chafer.

In reference to FIG. 2 and FIG. 3, the first lateral wall 15 that comprises a first wall section 151 and a second wall section 152, the second lateral wall 16, the third lateral wall 17, and the fourth lateral wall 18 complete the insulating member 1 of the present invention. More specifically, the first wall section 151 is adjacently positioned with the second lateral wall 16 creating a first elongated extremity of the insulating member 1. The third lateral wall 17 is adjacently positioned with the second lateral wall 16 opposite from the first wall section 151. Similarly, the fourth lateral wall 18 is adjacently positioned with the third lateral wall 17 opposite from the second lateral wall 16. The second wall section 152 is adjacently positioned with the fourth lateral wall 18, where the second wall section 152 is oppositely positioned from the third lateral wall 17 and creates a second elongated extremity of the insulating member 1.

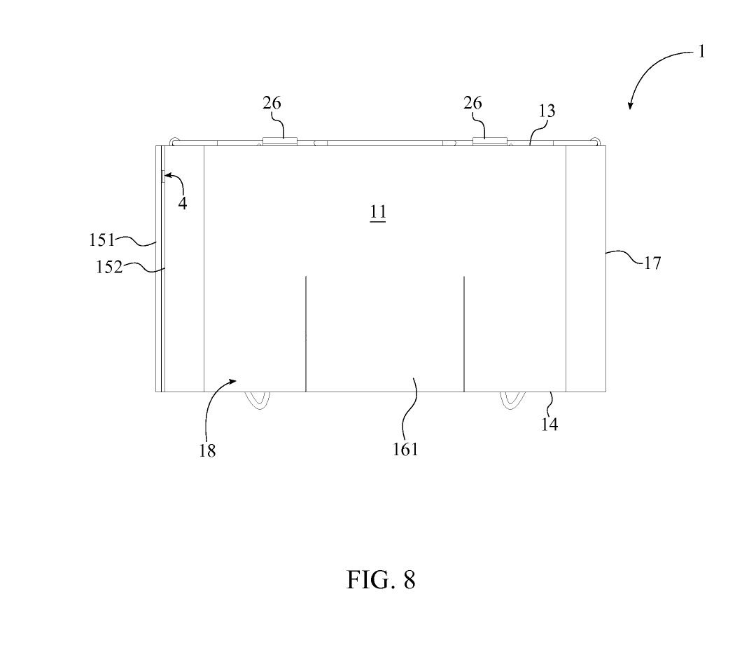

In reference to FIG. 7 and FIG. 8, the second lateral wall 16 and the fourth lateral wall 18 each comprise a slit opening 161, where the slit opening 161 is centrally positioned on the second lateral wall 16 and the fourth lateral wall 18 adjacent to the bottom edge 14. The slit openings 161 provide an access opening for the inside of the metal chafer as the slit openings 161 can be lift opened from the bottom edge 14. The users of the present invention can use the slit openings 161 to ignite the chafing fuel, check the chafing fuel flame during the usage, and to extinguish the chafing fuel. Since the slit openings 161 are positioned flush with the second lateral wall 16 and the fourth lateral wall 18 without any offset, the slit openings 161 provide a continuation of material within the insulating member 1 providing an esthetically pleasing exterior panel 11.

The insulating member 1 is preferably made from heat and flame resistant materials, such as Class A/Class 1 reflective insulation materials. This material is sufficiently flexible such that the insulating member 1 can go from flat as seen in FIG. 1, to a wrap around the metal chafer as seen in FIG. 4. Additionally, the material is not so flexible that it is readily deformed by wind forces, thus the insulating member 1 is capable of preventing the wind from reaching and extinguishing the chafing fuel. The insulating properties of the insulating member 1 also help to increase the efficiency of the chafing fuel by forcing more heat into the food instead of letting the heat escape into the environment. Furthermore, the flame resistance property of the material ensures that the insulating member 1 does not ignite and only suffers minor charring and discoloration at worst, if the insulating member 1 is exposed to the burning chafing fuel.

In reference to FIG. 3 and FIG. 4, the plurality of tabs 2 is connected to the insulating member 1, where the plurality of tabs 2 attaches the insulating member 1 with the metal chafer. Each of the plurality of tabs 2, which are formed into rectangular shaped protrusions, comprises a distal end 21 and a proximal end 22 in such way that the distal end 21 and the proximal end 22 are oppositely positioned from each other along each of the plurality of tabs 2. The proximal end 22 of each of the plurality of tabs 2 is permanently connected with the interior panel 12 adjacent to the top edge 13. The distal end 21 of each of the plurality of tabs 2 is looped and removably attached with the interior panel 12 by each of the plurality of tab fasteners 3. More specifically, the created loop of each of the plurality of tabs 2 is positioned around the frame of the metal chafer so that the insulating member 1 can be hanged from the metal chafer. When the distal end 21 of each of the plurality of tabs 2 removably attached with the interior panel 12, the distal ends 21 are positioned below the respective proximal ends 22 of the plurality of tabs 2 where each of the plurality of tab fasteners 3 is positioned in between the distal ends 21 and the interior panel 12.

In reference to FIG. 3, each of the plurality of tab fasteners 3, preferably a hook-and-loop fastener, adjacently positions with the top edge 13 and comprises a loop portion 31 and a hook portion 32. More specifically, the loop portion 31 is connected on the interior panel 12 and the hook portion 32 is connected on the distal end 21 of each of the plurality of tabs 2. Even though hook-and-loop fasteners are used within the present invention, it is obvious that other methods of fasteners, such as magnet fasteners, button fasteners, zippers, and snap button fasteners, can be used within the present invention in order to attach the insulating member 1 with the metal chafer.

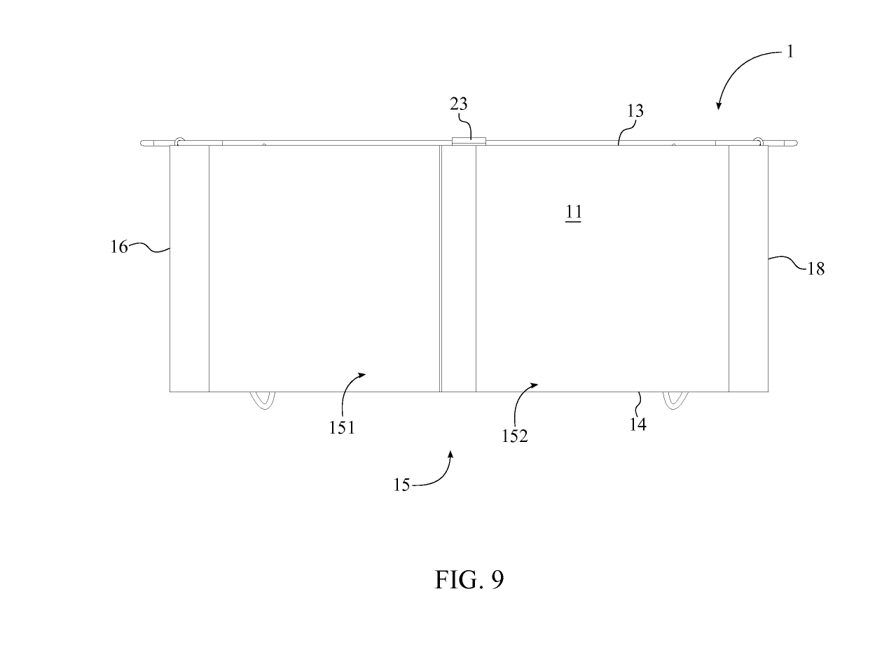

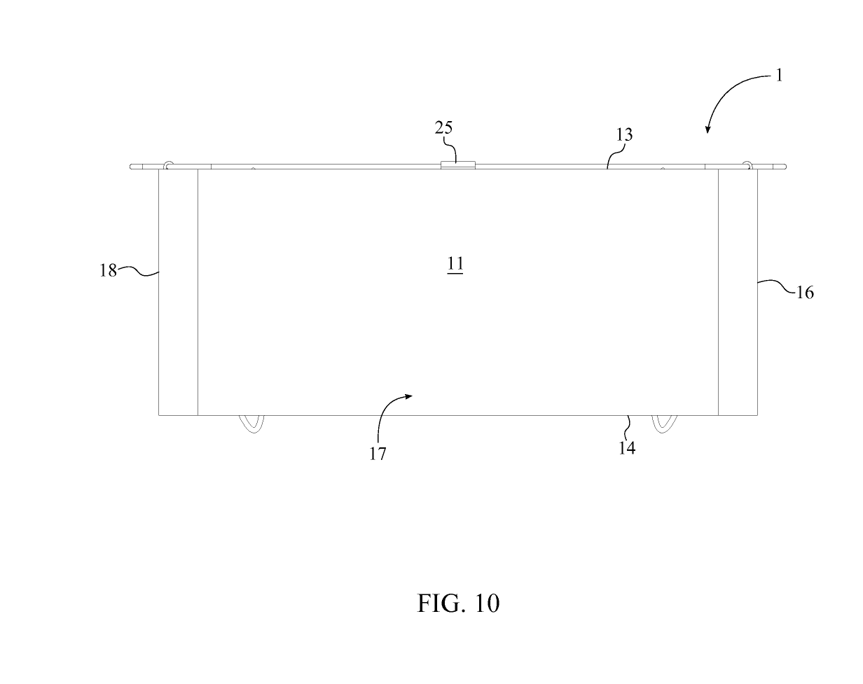

As shown in FIG. 4, FIG. 7, FIG. 8, FIG. 9, and FIG. 10, the plurality of tabs 2 comprises a first tab 23, a pair of second tabs 24, a third tab 25, and a pair of fourth tabs 26, where the first tab 23, the pair of second tabs 24, the third tab 25, and the pair of fourth tabs 26 selectively attach the insulating member 1 with the metal chafer. More specifically, the first tab 23 is centrally positioned on the first lateral wall 15 as the first tab 23 supports the first lateral wall 15. The pair of second tabs 24 centrally position on the second lateral wall 16, where the pair of second tabs 24 attaches the second lateral wall 16. The third tab 25 is centrally positioned on the third lateral wall 17 in such way that the third tab 25 attaches the third lateral wall 17. The pair of fourth tabs 26 is centrally positioned on the fourth lateral wall 18, where the pair of fourth tabs 26 supports the fourth lateral wall 18.

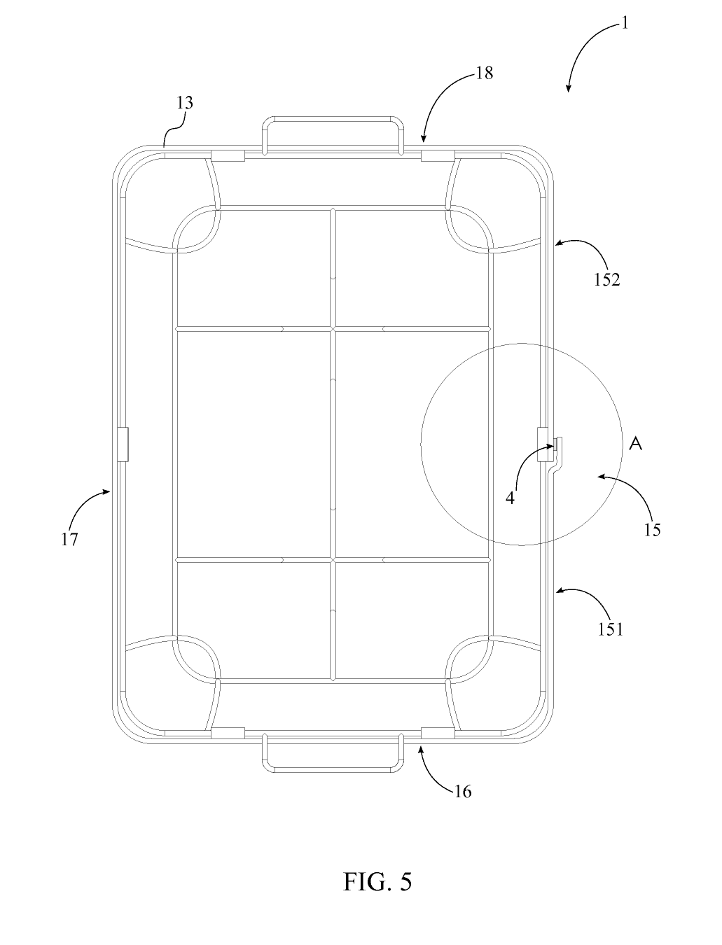

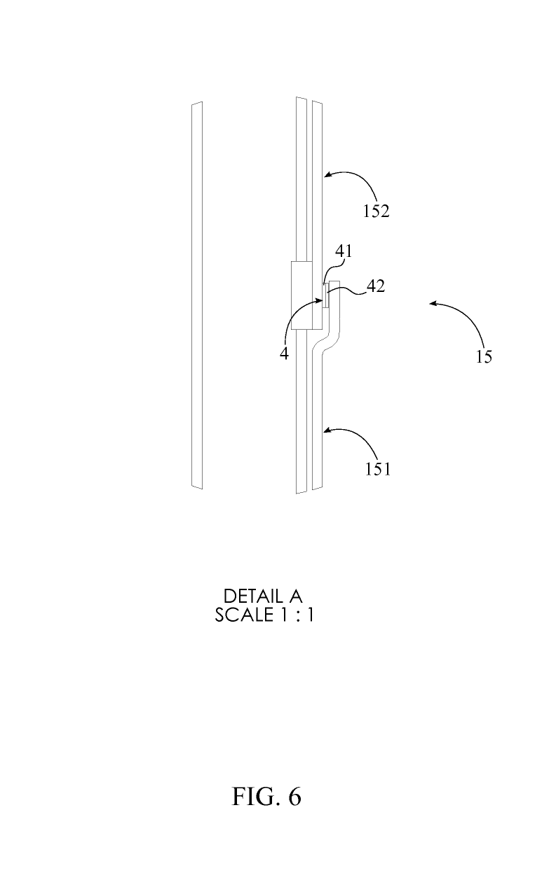

The at least one wall fastener 4 is located at the first and second elongated extremities of the insulating member 1 as can be seen in FIG. 2, FIG. 3, FIG. 5 and FIG. 6. The purpose of the at least one wall fastener 4 is to allow the insulating member 1 to be secured around the metal chafer as a closed loop, thus entirely blocking out any wind from the sides. The at least one wall fastener 4 can position in between the top edge 13 and the bottom edge 14 of insulating member 1. A hook-and-loop fastener is used as the at least one wall fastener 4 in the preferred embodiment as at least one wall fastener 4 comprises a hook section 42 and a loop section 41, however it is obvious that other fastening methods may be used which are suitable for connecting overlapping segments of insulating member 1. Some examples of other suitable fastening methods for the at least one wall fastener 4 can include, but are not limited to buttons, zippers, snap buttons, and magnets. As for the proper placement of the at least one wall fastener 4 within the preferred embodiment, the hook section 42 is connected on the interior panel 12 of the first wall section 151 adjacent to the top edge 13, and the loop section 41 is connected on the exterior panel 11 of the second wall section 152 adjacent to the top edge 13. As a result, when the insulating member 1 is wrapped around the metal chafer, the first and second elongated extremities of the insulating member 1 can be removably attached to each other by the at least one wall fastener 4.

Additionally, the present invention is primarily intended for use by caterers at social events. In response to this, the insulating member 1 may also bear some decorative coloration, patterns, decorative images, or any combination thereof to enhance the marketability and the esthetic appearance of the present invention.

Although the invention has been explained in relation to its preferred embodiment, it is to be understood that many other possible modifications and variations can be made without departing from the spirit and scope of the invention as hereinafter claimed.

What is claimed is:

1. A chafer protective wrap comprises:
an insulating member;
a plurality of tabs;
a plurality of tab fasteners;
at least one wall fastener;
the insulating member comprises an exterior panel, an interior panel, a top edge, a bottom edge, a first lateral wall, a second lateral wall, a third lateral wall, and a fourth lateral wall; and
each of the plurality of tabs comprises a distal end and a proximal end.

2. The chafer protective wrap as claimed in claim 1 comprises:
the exterior panel being oppositely positioned from the interior panel along the insulating member;
the top edge being positioned atop the exterior panel and the interior panel; and
the bottom edge being positioned along the exterior panel and the interior panel opposite from the top edge.

3. The chafer protective wrap as claimed in claim 1 comprises:
the first lateral wall comprises a first wall section and a second wall section;
the first wall section being adjacently positioned with second lateral wall;
the third lateral wall being adjacently positioned with the second lateral wall opposite from the first wall section;
the fourth lateral wall being adjacently positioned with the third lateral wall opposite from the second lateral wall; and
the second wall section being adjacently positioned with the fourth lateral wall opposite from the third lateral wall.

4. The chafer protective wrap as claimed in claim 1 comprises:
the second lateral wall and the fourth lateral wall each comprise a slit opening; and
the slit opening being centrally positioned on the second lateral wall and fourth lateral wall adjacent to the bottom edge.

5. The chafer protective wrap as claimed in claim 1 comprises:
the distal end and the proximal end being oppositely positioned from each other along each of the plurality of tabs;
the proximal end of each of the plurality of tabs being permanently connected with the interior panel;
the proximal end being adjacently positioned with the top edge;
the distal end of each of the plurality of tabs being looped and removably attached with the interior panel by each of the plurality of tab fasteners;
the distal end of the each of the plurality of tabs being positioned below the proximal end of each of the plurality of tabs; and
each of the plurality of tab fasteners being positioned in between the distal end of each of the plurality of tabs and the interior panel.

6. The chafer protective wrap as claimed in claim 5 comprises:
each of the plurality of tab fasteners comprises a loop portion and a hook portion;
the loop portion being connected on the interior panel; and
the hook portion being connected on the distal end of each of the plurality of tabs.

7. The chafer protective wrap as claimed in claim 5 comprises:
the plurality of tabs comprises a first tab, a pair of second tabs, a third tab, and a pair of fourth tabs;
the first tab being centrally positioned on the first lateral wall;
the pair of second tabs being centrally positioned on the second lateral wall;
the third tab being centrally positioned on the third lateral wall; and
the pair of fourth tabs being centrally positioned on the fourth lateral wall.

8. The chafer protective wrap as claimed in claim 1 comprises:
the first wall section and the second wall section being attached to each other by the at least one wall fastener; and
the at least one wall fastener being positioned in between the first wall section and the second wall section.

9. The chafer protective wrap as claimed in claim 8 comprises:
the at least one wall fastener comprises a loop section and a hook section;
the hook section being connected on the first wall section adjacent to the top edge;
the hook section being positioned on the interior panel;
the loop section being connected on the second wall section adjacent to the top edge; and
the loop section being positioned on the exterior panel.

10. A chafer protective wrap comprises:
an insulating member;
a plurality of tabs;
a plurality of tab fasteners;
at least one wall fastener;
the insulating member comprises an exterior panel, an interior panel, a top edge, a bottom edge, a first lateral wall, a second lateral wall, a third lateral wall, and a fourth lateral wall;
each of the plurality of tabs comprises a distal end and a proximal end;
the exterior panel being oppositely positioned from the interior panel along the insulating member;
the top edge being positioned atop the exterior panel and the interior panel; and
the bottom edge being positioned along the exterior panel and the interior panel opposite from the top edge.

11. The chafer protective wrap as claimed in claim 10 comprises:
the first lateral wall comprises a first wall section and a second wall section;
the first wall section being adjacently positioned with second lateral wall;
the third lateral wall being adjacently positioned with the second lateral wall opposite from the first wall section;
the fourth lateral wall being adjacently positioned with the third lateral wall opposite from the second lateral wall; and
the second wall section being adjacently positioned with the fourth lateral wall opposite from the third lateral wall.

12. The chafer protective wrap as claimed in claim 10 comprises:
the second lateral wall and the fourth lateral wall each comprise a slit opening; and
the slit opening being centrally positioned on the second lateral wall and fourth lateral wall adjacent to the bottom edge.

13. The chafer protective wrap as claimed in claim 10 comprises:
the distal end and the proximal end being oppositely positioned from each other along each of the plurality of tabs;
the proximal end of each of the plurality of tabs being permanently connected with the interior panel;
the proximal end being adjacently positioned with the top edge;
the distal end of each of the plurality of tabs being looped and removably attached with the interior panel by each of the plurality of tab fasteners;
the distal end of the each of the plurality of tabs being positioned below the proximal end of each of the plurality of tabs; and
each of the plurality of tab fasteners being positioned in between the distal end of each of the plurality of tabs and the interior panel.

14. The chafer protective wrap as claimed in claim 13 comprises:
each of the plurality of tab fasteners comprises a loop portion and a hook portion;
the loop portion being connected on the interior panel; and
the hook portion being connected on the distal end of each of the plurality of tabs.

15. The chafer protective wrap as claimed in claim 13 comprises:
the plurality of tabs comprises a first tab, a pair of second tabs, a third tab, and a pair of fourth tabs;
the first tab being centrally positioned on the first lateral wall;
the pair of second tabs being centrally positioned on the second lateral wall;
the third tab being centrally positioned on the third lateral wall; and
the pair of fourth tabs being centrally positioned on the fourth lateral wall.

16. The chafer protective wrap as claimed in claim 10 comprises:
the first wall section and the second wall section being attached to each other by the at least one wall fastener; and
the at least one wall fastener being positioned in between the first wall section and the second wall section.

17. The chafer protective wrap as claimed in claim 16 comprises:
the at least one wall fastener comprises a loop section and a hook section;
the hook section being connected on the first wall section adjacent to the top edge;
the hook section being positioned on the interior panel;
the loop section being connected on the second wall section adjacent to the top edge; and
the loop section being positioned on the exterior panel.
